(19) United States
(12) Patent Application Publication
(10) Pub. No.: US 2026/0195401 A1
(43) Pub. Date: Jul. 9, 2026

(54) ACCELERATION OF ACTIVATION FUNCTIONS IN MACHINE LEARNING

(71) Applicant: QUALCOMM Incorporated, San Diego, CA (US)

(72) Inventors: Jamie Menjay LIN, San Diego, CA (US); Jian SHEN, San Diego, CA (US)

(21) Appl. No.: 19/012,477

(22) Filed: Jan. 7, 2025

(51) Int. Cl. G06F 17/16

(52) U.S. Cl. CPC G06F 17/16

(57) ABSTRACT

Certain aspects provide techniques and apparatus for machine learning. An example method generally includes generating an approximation of an output vector component of a normalized exponential function of a data vector. Generating the approximation includes (i) determining, for each data vector component, an approximation of a natural exponential function of the data vector component, based on performing a hierarchical table lookup with multiple bits of the data vector component, (ii) performing an accumulation of the approximations of the natural exponential function of the data vector components, based on the hierarchical table lookups, (iii) using the accumulation as an approximation of a sum of the natural exponential function, and (iv) dividing, for each data vector component, the approximation of the natural exponential function by the approximation of the sum. An output of a machine learning model is generated based on the approximation of the at least one output vector component.

### INTRODUCTION

Aspects of the present disclosure relate to machine learning.

Many machine learning models (e.g., deep neural networks (DNNs), large language models (LLMs), large vision models (LVMs), large multimodal models (LMMs), and the like) use activation functions for training and inferencing. For example, certain machine learning models use activation functions to perform diverse computations in the hidden layers of the machine learning model as well as in the output layer of the machine learning model. Often, for problems in which the input may have one of multiple possible outcomes, machine learning models may use an activation function in the output layer to classify input(s) into one of multiple outcomes. For example, the softmax activation function (also known as the normalized exponential function) generally converts a set of raw output values into a probability distribution over multiple outcomes or alternatives.

### BRIEF SUMMARY

Certain aspects provide a processor-implemented method for machine learning. The processor-implemented method generally includes generating an approximation of at least one component of an output vector of a normalized exponential function of a data vector. Generating the approximation includes: determining, for each component of the data vector, an approximation of a natural exponential function of the component of the data vector, based on performing a hierarchical table lookup with two or more bits of the component of the data vector; performing an accumulation of the approximations of the natural exponential function of the components of the data vector, based at least in part on the hierarchical table lookups; using the accumulation as an approximation of a sum of the natural exponential function; and dividing, for each component of the data vector, the approximation of the natural exponential function by the approximation of the sum of the natural exponential function to generate the approximation of the at least one component of the output vector. The processor-implemented method also includes generating an output of a machine learning model based on the approximation of the at least one component of the output vector.

Other aspects provide processing systems configured to perform the aforementioned method as well as those described herein; non-transitory, computer-readable media comprising instructions that, when executed by one or more processors of a processing system, cause the processing system to perform the aforementioned method as well as those described herein; a computer program product embodied on a computer-readable storage medium comprising code for performing the aforementioned method as well as those further described herein; and a processing system comprising means for performing the aforementioned method as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for accelerating processing of the softmax activation function in machine learning models, according to certain aspects of the present disclosure.

FIG. 2 depicts an example workflow for accelerating processing of the natural exponential function associated with the softmax activation function in machine learning models, according to certain aspects of the present disclosure.

FIG. 3 depicts an example workflow for accelerating processing of an accumulation of the approximations of the natural exponential function associated with the softmax activation function in machine learning models, according to certain aspects of the present disclosure.

FIG. 4A illustrates an example structure of a processor data path for executing a processor instruction for accumulation of the approximations of the natural exponential function associated with the softmax activation function in machine learning models, according to certain aspects of the present disclosure.

FIG. 4B illustrates an example timing diagram for execution of a processor instruction for accumulation of the approximations of the natural exponential function associated with the softmax activation function in machine learning models, according to certain aspects of the present disclosure.

FIG. 5 illustrates example operations for efficiently performing a softmax activation function in a processing system, according to certain aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, techniques for efficiently performing activation functions in machine learning models are provided.

A wide variety of machine learning models use activation functions to perform complex mappings between inputs and outputs. As an illustrative example, the softmax activation function (also known as the normalized exponential function, the softmax function, or softargmax) is a special type of activation function generally used by various models (e.g., generative machine learning models, such as diffusion models, LLMs, LVMs, LMMs, among others) for problems in which an input may have one of multiple outcomes, for example. The softmax activation function may operate on a vector, which represents the raw predictions or scores for each outcome computed by previous layers (e.g., hidden layers) of a machine learning model.

Given an input vector of K real numbers, the softmax activation function normalizes the input vector into a probability distribution consisting of K probabilities proportional to the exponentials of the input numbers. For example, the softmax activation function (σ: [symbol] →(0,1)^{K}, where K>1) takes a vector z=(z₁, . . . , z_{K})∈ [symbol] and computes each component of vector σ(z)∈(0,1)^{K} with the following Equation 1:

$${σ ( z )}_{i} = \frac{{e}^{{z}_{i}}}{{\sum }_{j = 1}^{K} {e}^{{z}_{j}}} \qquad ( 1 )$$

That is, the softmax activation function (σ) applies the natural exponential function to each component zᵢ of the input vector z, and normalizes these values by dividing by the sum of all these exponentials. The normalization ensures that the sum of the components of the output vector σ(z) is 1.

One challenge with the softmax activation function is that the softmax activation function can cause a computation bottleneck in certain computing devices (e.g., resource-constrained devices, such as smartphones and other devices). As an illustrative example, a significant amount (e.g., 40% and above) of the overall latency associated with model inferencing (e.g., diffusion model inferencing) may be attributed to the softmax calculation alone.

With conventional techniques for computation of the softmax activation function, the substantial computational expense associated with the softmax activation function may be a consequence of performing an accumulation of exponent terms for all components of the input vector (e.g., vector z). For example, conventional techniques for computation of the softmax activation function generally involve (i) initially summing all the exponents, (ii) then calculating the individual probabilities, and (iii) then dividing each individual probability by the sum. Consequently, with conventional techniques, the division by the sum cannot start until all the exponents are summed. Additionally, in certain cases, the substantial computational expense associated with conventional computation of the softmax activation function may be particularly problematic in cases involving large token size (e.g., LLM, LVM, etc.), high-throughput, and/or low-power scenarios. In such cases, the substantial computational expense associated with conventional computation of the softmax activation function may make implementing a machine learning model on certain computing devices (e.g., smartphone) infeasible. For example, the computationally complex operations associated with the softmax activation function generally consume more power, generate more heat, and are completed less quickly than less computationally complex operations. Consequently, the execution of such computationally complex operations may result in reduced battery life and delays in the ability to reassign computing resources (e.g., compute cores on a processor, memory, etc.) to other tasks executing on a device.

Further, with conventional techniques for computation of the softmax activation function, the accuracy of the softmax activation function may be impacted by the activation bitwidth. For example, lower activation bitwidths can lead to faster computation of the softmax activation function but may also decrease the accuracy of the softmax activation function. In the case of the softmax activation function, the exponential function poses a significant accuracy challenge to fixed-point arithmetic for edge devices. Some conventional approaches to the exponential function include utilizing a lookup table (e.g., Nᵢₙ-bit input, Nₒᵤₜ-bit output), performing an N^{th} order approximation of a Taylor series, or performing a piecewise linear approximation. In all of these conventional approaches, however, reducing the activation bitwidth can significantly reduce the accuracy of the softmax activation function, directly impacting the accuracy of a machine learning model output and potentially downstream model tasks.

Certain aspects of the present disclosure provide techniques for efficiently performing activation functions, such as the softmax activation function, in machine learning models. As discussed in further detail herein, instead of using a Taylor series, piecewise linear approximation, or standard lookup table to approximate the natural exponential function, certain aspects provide techniques for approximating the natural exponential function (e.g., numerator term) for the softmax activation function, based on a hierarchical table lookup with multiple (e.g., two or more) bits of the input vector (e.g., vector z). In certain aspects, the hierarchical table lookup may involve multiple hierarchical levels (e.g., multi-levels or multi-tiers) and multiple banks of lookup tables to allow for a speculative parallel table lookup for the natural exponential function. By performing a speculative parallel table lookup for the natural exponential function, the indexing of the table lookup may be broken down to two or more hierarchical levels, reducing latency and power compared to conventional approaches to implementing the natural exponential function.

As also discussed in further detail herein, certain aspects provide techniques for efficiently approximating the sum of the natural exponential function (e.g., denominator term) for the softmax activation function, based on the hierarchical table lookups. In certain aspects, approximating the sum of the natural exponential function may involve performing an accumulation of the natural exponential function for a subset of components of the input vector. The subset of components of the input vector may be components that satisfy a predetermined condition, which is based on a predefined bitwidth threshold. By performing the accumulation of the natural exponential function for a subset of components of the input vector, certain aspects of the present disclosure may allow for increased efficiency in approximating the sum of the natural exponential function.

As such, the techniques described herein for approximating the softmax activation function may reduce the computational complexity associated therewith in a processing system, which may allow for the utilization of fewer compute resources to complete various tasks for machine-learning-model-based operations. In turn, the techniques discussed herein may reduce the amount of power used by computing devices to perform the softmax activation function and/or accelerate processing of the softmax activation function, relative to the amount of power and/or amount of time used in conventional computations of the softmax activation function in a processing system.

### Example Workflow for Softmax Acceleration in Machine Learning Models

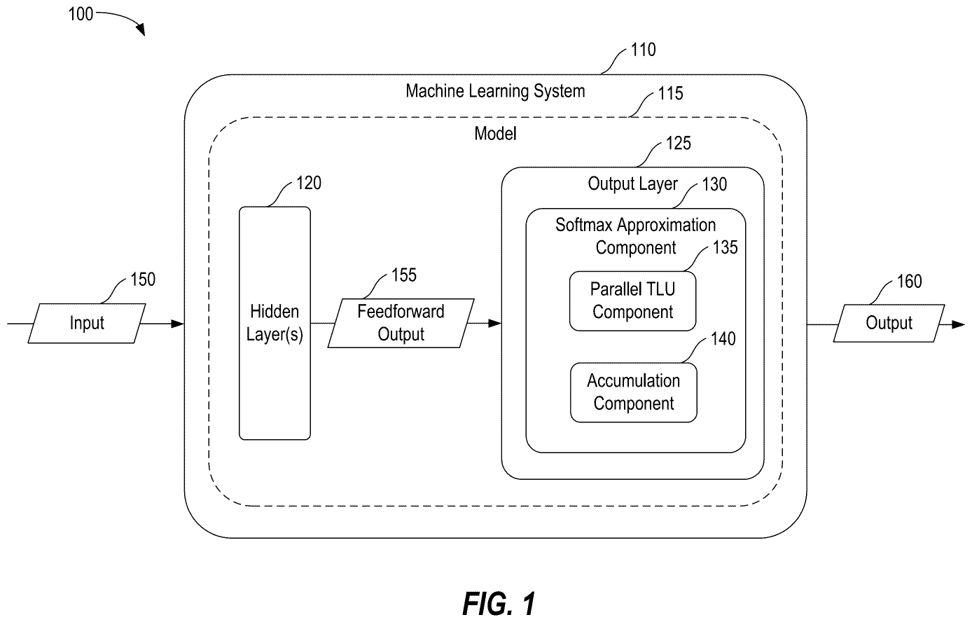

FIG. 1 depicts an example workflow 100 for accelerating processing of the softmax activation function in machine learning models, according to certain aspects of the present disclosure.

In the depicted workflow 100, a machine learning system 110 accesses an input 150 to generate an output 160. As used herein, “accessing” data may generally include receiving, requesting, retrieving, obtaining, generating, collecting, to otherwise gaining access to the data. Although depicted as a discrete computing system for conceptual clarity, in some aspects, the operations of the machine learning system 110 may be implemented using hardware, software, or a combination of hardware and software, and may be distributed across any number and variety of systems.

In some aspects, the input 150 includes an ordered sequence of elements (referred to as “tokens” in some aspects). The particular contents and format of the input 150 may vary depending on the particular implementation. For example, if the machine learning system 110 includes an LLM, the input 150 may include natural language text (e.g., where each element or token corresponds to a character, word (or portion thereof), or phrase). Similarly, the particular content and format of the output 160 may vary depending on the particular implementation. For example, the output 160 may include a natural language textual string, an image, a probability distribution, and the like.

As illustrated, the machine learning system 110 includes or implements a machine learning model 115 (hereinafter, “model 115”). Although a single model 115 is depicted for conceptual clarity, in some aspects, the machine learning system 110 may include or implement multiple models 115. The model 115 is generally representative of a variety of machine learning models (e.g., generative machine learning models, such as diffusion models, LLMs, LVMs, LMMs, among others). As illustrated, the model 115 may include or implement one or more hidden layers 120 and an output layer 125. As part of the operations of the model 115, each hidden layer 120 may apply one or more activation functions on the input data either from an input layer (e.g., that accessed input 150) or from a previous hidden layer 120, e.g., to learn patterns in the data. A last hidden layer 120 may generate feedforward output 155 and provide the feedforward output 155 as input to the output layer 125. The output layer 125 may apply an activation function on the feedforward output (e.g., processed data from previous layers) to generate the output 160.

As noted, in certain cases, the model 115 may employ the softmax activation function as the last activation function (e.g., within the output layer 125) to normalize the feedforward output 155 to a probability distribution over one or more predicted outcomes. That is, in cases where the output layer 125 employs a softmax activation function, the output 160 may include an output vector of probabilities (e.g., vector σ(z)) with each component of the output vector corresponding to the probability of a particular input belonging to a particular outcome. As noted above, assuming the feedforward output 155 includes an input data vector z=(z₁, . . . , z_{K})∈ [symbol] , the output 160 may include an output vector σ(z)∈(0,1)^{K}, where each component of the output vector σ(z) is defined according to Equation 1.

To reduce the substantial computational expense associated with computation of the softmax activation function, certain aspects described herein provide techniques for accelerating the processing of the softmax activation function within a processing system. As illustrated in FIG. 1, the output layer 125 may include or implement a softmax approximation component 130, which is configured to perform one or more techniques described herein for approximating the softmax activation function. As described in further detail herein, the softmax approximation component 130 may implement a vector acceleration of the softmax activation function using a hierarchical parallel lookup table based on multiple bits of the feedforward output (e.g., input vector z).

In certain aspects, the softmax approximation component 130 includes a parallel table lookup (TLU) component 135 and an accumulation component 140. Although depicted as a discrete component for conceptual clarity, in some aspects, the operations of the softmax approximation component 130 (including the parallel TLU component 135 and the accumulation component 140) may be implemented using hardware, software, or a combination of hardware and software, and may be distributed across any number and variety of systems.

In certain aspects, the parallel TLU component 135 is configured to accelerate processing of a numerator term (e.g., e^{z}^{ᵢ}) of the softmax activation function defined in Equation 1, based at least in part on performing a hierarchical table lookup with multiple bits of the feedforward output (e.g., input vector z). Additionally, in certain aspects, the accumulation component 140 is configured to accelerate processing of a denominator term

$$( e . g . , {\sum }_{j = 1}^{K} {e}^{{z}_{j}} )$$

of the softmax activation function defined in Equation 1, based at least in part on the hierarchical table lookups. Note, the parallel TLU component 135 and the accumulation component 140 are described in greater detail herein.

Advantageously, the accelerated processing of the softmax activation function discussed herein may significantly improve performance of the machine learning system 110. In some aspects, for example, the accelerated processing of the softmax activation function discussed herein may reduce the computational complexity associated with computation of the softmax activation function in a processing system, which may allow for the utilization of fewer compute resources to complete various tasks for machine-learning-model-based operations. Additionally, as discussed above, the techniques discussed herein may reduce the amount of power used by the machine learning system 110 to perform the softmax activation function and/or accelerate processing of the softmax activation function, relative to the amount of power and/or amount of time used in conventional computations of the softmax activation function in a processing system.

### Example Workflow for Acceleration of the Natural Exponential Function of the Softmax Activation Function in Machine Learning Models

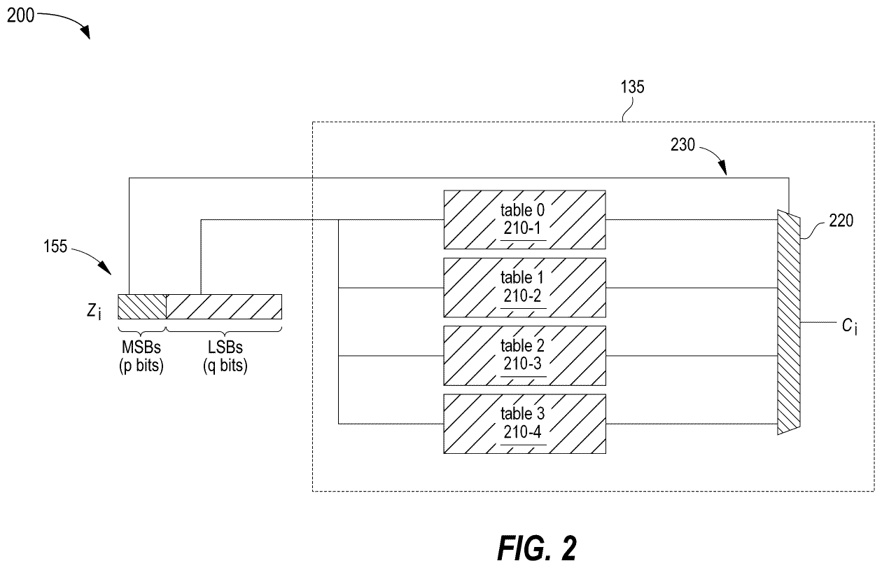

FIG. 2 depicts an example workflow 200 for accelerating processing of the natural exponential function associated with the softmax activation function in machine learning models, according to certain aspects of the present disclosure. In certain aspects, the workflow 200 is performed by the machine learning system 110 (including one or more components thereof, such as the parallel TLU component 135) of FIG. 1. Note that the workflow 200 may be implemented in hardware (e.g., by an arithmetic logic unit (ALU)), software (e.g., in memory, such as static random-access memory (SRAM)), or a combination thereof.

The machine learning system 110 (including components thereof) may use vector processing techniques for processing the softmax activation function defined in Equation 1. Such vector processing techniques generally allow for multiple data elements arranged in a one-dimensional array (referred to as a vector) to be processed in parallel or substantially in parallel by storing multiple words of a defined length in a vector register and executing operations (e.g., implemented using a vector instruction set that allows for such parallel processing of data in a vector) on a per-word basis using dedicated hardware for each word. For example, a vector register may be a 1024-bit register that supports the storage and processing of (1) 32 elements with a length of 32 bits per element; (2) 64 elements with a length of 16 bits per element; or (3) 128 elements with a length of 8 bits per element.

In certain aspects, the machine learning system 110 may approximate the natural exponential function associated with the softmax activation function, based on performing a hierarchical table lookup using multiple bits of the feedforward output 155. In some cases, the standard table lookup for the natural exponential function (e.g., e^{z}^{ᵢ}) may have a longer latency than normal ALU instructions, especially in cases where the numeric bitwidth of an input data vector component (e.g., zᵢ) is large, such as 16 bits for a 16-bit integer (INT16) or 16-bit half-precision floating-point (FP16). For example, 16 bits for INT16 or FP16 may correspond to implementing a table with 64,000 rows in memory (e.g., SRAM).

To accelerate the vector processing associated with performing a table lookup for approximating the natural exponential function, certain aspects provide techniques for performing a speculative parallel table lookup for the natural exponential function. In such a speculative parallel table lookup, the indexing of the table lookup is broken down to two or more hierarchical levels for speculative parallel decoding, e.g., in order to reduce latency and power. In certain aspects, the speculative parallel table lookup may involve partitioning the memory (e.g., SRAM) into multiple banks 210 (i.e., multiple lookup tables). The workflow 200 depicted in FIG. 2, for example, illustrates four banks 210 (e.g., table0 210-1, table1 210-2, table2 210-3, and table3 210-4). In certain aspects, p bits of the most significant bits (MSBs) of the input data vector component (e.g., zᵢ) (e.g., within feedforward output 155) may be used to indicate the memory bank index, and q bits of the least significant bits (LSBs) of the input data vector component may be used to indicate the index into each bank.

By way of example, in the illustrated workflow 200, for a given input data vector component (e.g., zᵢ) (e.g., within feedforward output 155), the parallel TLU component 135 may select a bank (e.g., bank 210-1) from the multiple banks 210 based on p bits of the MSBs of the input data vector component. In addition, the parallel TLU component 135 may index each bank 210, based on the q bits of the LSBs of the input data vector component. The parallel TLU component 135 may determine, from the indexed banks, a lookup table entry that includes an approximation of the natural exponential function of the input data vector component (e.g., cᵢ=e^{z}^{ᵢ}), based on the p bits of the MSBs of the input data vector component. For example, in the illustrated workflow 200, as each bank 210 returns an entry, a multiplexer 220 is configured to select the appropriate lookup table entry based on the p bits of the MSBs of the input data vector component using control signal 230. The parallel TLU component 135 may write the table output cᵢ(from the multiplexer 220) into a destination vector register file.

In certain aspects, operations performed by the parallel TLU component 135 may be an operation executable by invoking a single instruction on a processing system implementing the parallel TLU component 135. For example, the single instruction may be a processor instruction (e.g., single instruction, multiple data (SIMD) processor instruction) (also known as a vector instruction) that instructs the processor to iteratively look up the hierarchical natural exponential function table for each input data vector component (e.g., zᵢ) and to write the table output cᵢ into a destination vector register file.

As noted, although a single bank of lookup tables is depicted for conceptual clarity, in some aspects, multiple banks of lookup tables may be used for the hierarchical table lookup. For example, in cases where the input data vector is highly clustered, for additional power savings, additional hierarchies with multiple banks of lookup tables may be used to further reduce power and achieve additional power savings.

Additionally, note that the input data vector may include data from fixed-point data types (e.g., INT8) or floating-point data types (e.g., FP8). In certain aspects, for floating-point data types, a floating-point data type of the activations may be used to index the hierarchical table lookups by first taking the MSBs of the exponent portion of the input data vector component and the remaining LSBs of the exponent portion of the input data vector component. In other aspects, for floating-point data types, a floating-point data type of the activations may be used to index the hierarchical table lookups by first taking the MSBs of the mantissa portion of the input data vector component and the remaining LSBs of the mantissa portion of the input data vector component.

### Example Workflow for Acceleration of an Accumulation of the Natural Exponential Function of the Softmax Activation Function in Machine Learning Models

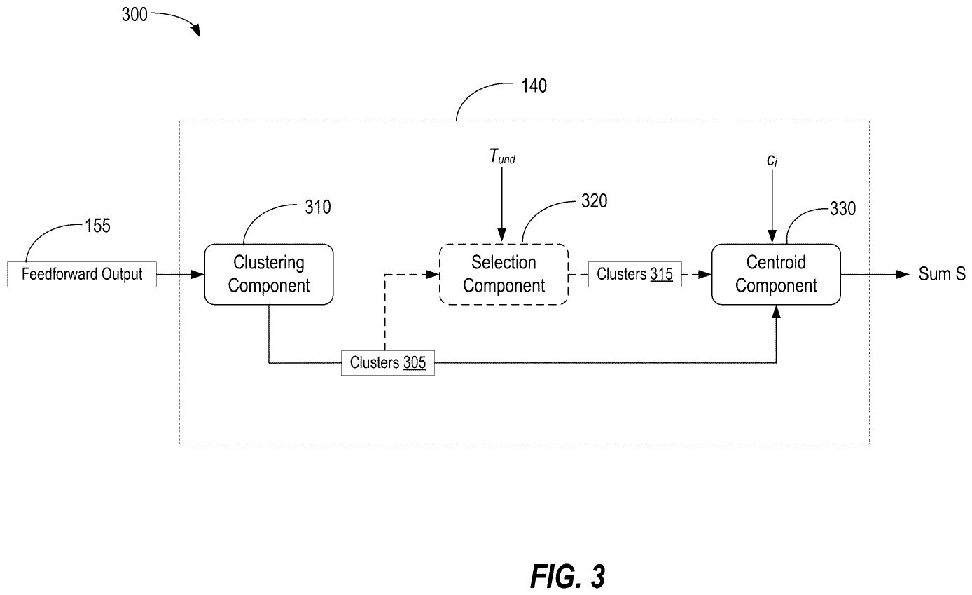

FIG. 3 depicts an example workflow 300 for accelerating processing of an accumulation of the approximations of the natural exponential function associated with the softmax activation function in machine learning models, according to certain aspects of the present disclosure. In certain aspects, the workflow 300 is performed by a machine learning system 110 (including one or more components thereof, such as the accumulation component 140) of FIG. 1. Note that the workflow 300 may be implemented in hardware (e.g., via an exponential TLU unit and a multiply and accumulate (MAC) unit), software (e.g., in memory, such as SRAM), or a combination thereof.

In the illustrated workflow 300, the accumulation component 140 may accelerate processing of the denominator term

$$( e . g . , {\sum }_{j = 1}^{K} {e}^{{z}_{j}} )$$

of the softmax activation function defined in Equation 1 by clustering components of the feedforward output 155 into multiple clusters 305 (or bins), each including a respective set of components of the feedforward output 155. Assuming the feedforward output 155 includes an input data vector z=(z₁, . . . , z_{K}), a clustering component 310 of the accumulation component 140 may cluster the data components of the input data vector z into M clusters: C₀, . . . , C_{M}. By way of example, assuming the inputs of the input data vector include [−101, −100, −99, −98, −97, 99, 100, 101], the clustering component 310 may define a first cluster (cluster 1) with [99, 100, 101] and a second cluster (cluster 2) with [−97, −98, −99, −100, −101].

In certain aspects, the clustering component 310 may determine the clusters 305 based at least in part on the training dataset for the machine learning model (e.g., model 115). For example, given the domain of the training dataset, the probabilistic distributions and characteristics of the data can be used to predefine minimums and maximums in the distribution. Based on the probabilistic densities, a suitable clustering (or binning) as well as the centroids or nominals for the clusters 305 may be determined.

In the illustrated workflow 300, the clusters 305 are provided to a centroid component 330 of the accumulation component 140. As part of the operations for accelerating processing of the denominator term

$$( e . g . , {\sum }_{j = 1}^{K} {e}^{{z}_{j}} )$$

of the softmax activation function defined in Equation 1, the centroid component 330 may use the centroid of each cluster and number of samples (or population size) of each cluster to calculate or approximate the Sum S corresponding to the denominator term

$$( e . g . , {\sum }_{j = 1}^{K} {e}^{{z}_{j}} )$$

of the softmax activation function defined in Equation 1.

In certain aspects, the centroid component 330 may approximate the Sum S, based on the clusters 305 and centroids during model inferencing. For example, in inference time, for a given set of input zᵢ values, the centroid component 330 may retrieve the respective approximation of the natural exponential function of the centroid of each cluster (cluster Cᵢ) from the parallel TLU component 135 (e.g., from table output cᵢ), determine the number of samples (sᵢ) (or population size) of each cluster (cluster Cᵢ), and approximate the Sum S according to Equation 2:

$${\sum }_{j = 1}^{K} {e}^{{z}_{j}} = {\sum }_{i} {S}_{i} {C}_{i} \qquad ( 2 )$$

where j is the index for input samples zⱼ, i is the index for the clusters (bins), cᵢ is the centroid for cluster Cᵢ, and sᵢ is the count for the number of zᵢ falling in the cluster C.

By way of example, assuming the clusters 305 include a first cluster (cluster 1) with [99, 100, 101] and a second cluster (cluster 2) with [−97, −98, −99, −100, −101] for an input data vector [−101, −100, −99, −98, −97, 99, 100, 101], the centroid component 330 may approximate the Sum S using Equation 2, which may be represented with the following:

$$S = {\sum }_{j = 1}^{M} \qquad ( 3 )$$

$${C}_{i} = 3 \cdot {e}^{100} + 5 \cdot {e}^{- 99}$$

where “100” is the centroid of cluster C₁, “3” is the population size of cluster C₁, “−99” is the centroid of cluster C₂, and “5” is the population size of cluster C₂.

In certain aspects, the accumulation component 140 may further accelerate processing of the denominator term

$$( e . g . , {\sum }_{j = 1}^{K} {e}^{{z}_{j}} )$$

of the softmax activation function defined in Equation 1 by skipping the accumulation of one or more clusters of the components of the feedforward output 155. In the illustrated workflow 300, for example, the clusters 305 may be provided to a selection component 320 of the accumulation component 140. In certain aspects, the selection component 320 is configured to select which clusters can be skipped for approximating the denominator term

$$( e . g . , {\sum }_{j = 1}^{K} {e}^{{z}_{j}} )$$

of the softmax activation function defined in Equation 1, and to output clusters 315. The clusters 315 may include a subset of the clusters 305, a subset of the data vector components associated with clusters 305, or a combination thereof.

In certain aspects, to select which clusters can be skipped for approximating the denominator term of the softmax activation function, the selection component 320 may determine (or otherwise be configured with) an underflow threshold (T_{und}) to compare against each component of the feedforward output 155. For example, the value of e^{z}^{ᵢ} may be negligible (e.g., zero or near zero) when zᵢ<T_{und}. Thus, the selection component 320 may exclude components of the feedforward output 155 from accumulation where zᵢ<T_{und}, and provide clusters 315, each including one or more components of the feedforward output where zᵢ≥T_{und}, to the centroid component 330 for approximating the Sum S (e.g., using Equation 2).

In some cases, T_{und} may be determined as a function of a predefined bitwidth (e.g., 7 non-sign bits of INT8), a max (zᵢ), or a combination thereof. In some cases, if the input z is known to have a normal distribution (a Gaussian distribution), then a standard deviation of the input z can be used to determine T_{und}.

In certain aspects, operations performed by the accumulation component 140 (including components thereof) may be an operation executable by invoking a single instruction on a processing system implementing the accumulation component 140. For example, the single instruction may be a processor instruction (e.g., SIMD processor instruction) (also known as a vector instruction) that instructs the processor to calculate the Sum S given a centroid vector, a size vector of a cluster, and a destination register. In an illustrative example, such a processor instruction may be represented as VClusterExpSum(Rd, Rss, Rmm), where source operand Rss contains the centroid vector, Rmm contains the size vector of the cluster, and Rd is the destination register.

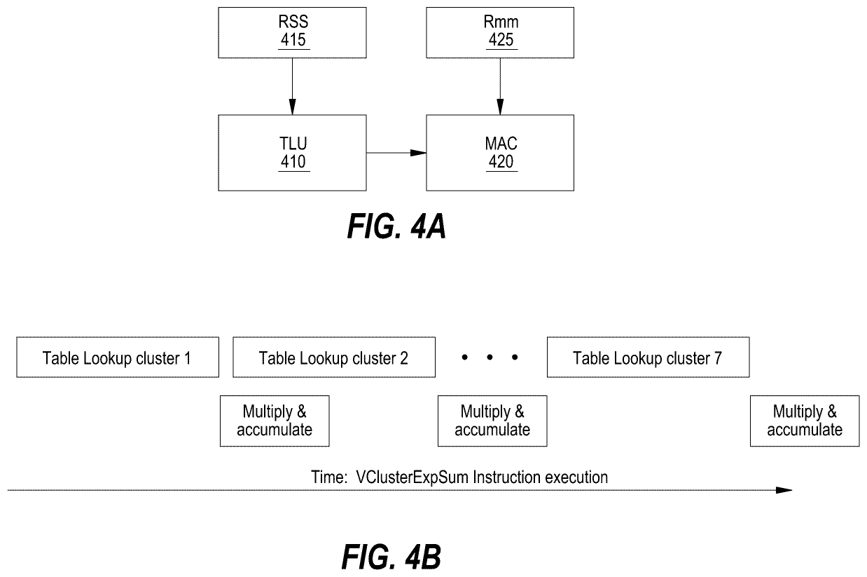

FIG. 4A illustrates an example structure of a processor data path for executing the processor instruction VClusterExpSum (Rd, Rss, Rmm), and FIG. 4B illustrates a timing diagram for execution of the processor instruction VClusterExpSum (Rd, Rss, Rmm).

As shown in FIG. 4A, the source operand Rss 415 is provided to a TLU unit 410, which is configured to perform a hierarchical table lookup for approximating the natural exponential function of the source operand Rss 415. As also shown, the MAC unit 420 obtains (i) the approximation of the natural exponential function of the source operand Rss 415 from the TLU unit 410 and (ii) Rmm 425, and approximates the Sum S using Equation 2. As illustrated in FIG. 4B, in certain aspects, the operations performed by the TLU unit 410 and the MAC unit 420 may be performed concurrently (e.g., in parallel or substantially in parallel). For example, the table lookup for cluster 2 may be performed while the accumulation is performed based on the table lookup for cluster 1, the table lookup for cluster 3 may be performed while the accumulation is performed based on the table lookup for cluster 2, the table lookup for cluster 4 may be performed while the accumulation is performed based on the table lookup for cluster 3, and so on. In certain aspects, the table lookup operations described herein may be executed on a first processor thread and the accumulation operations described herein may be executed on a second processor thread.

### Example Operations for Machine Learning

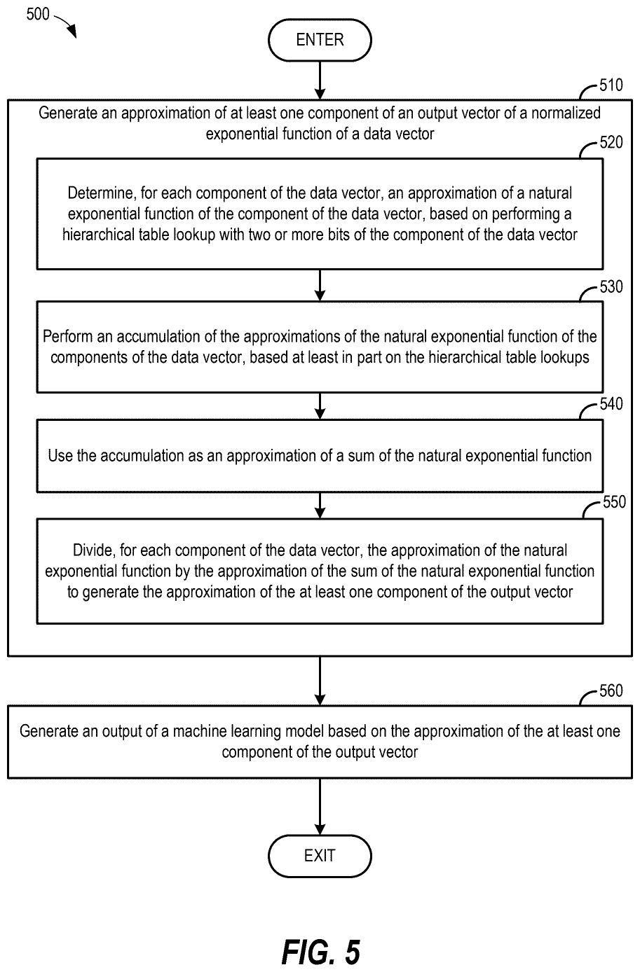

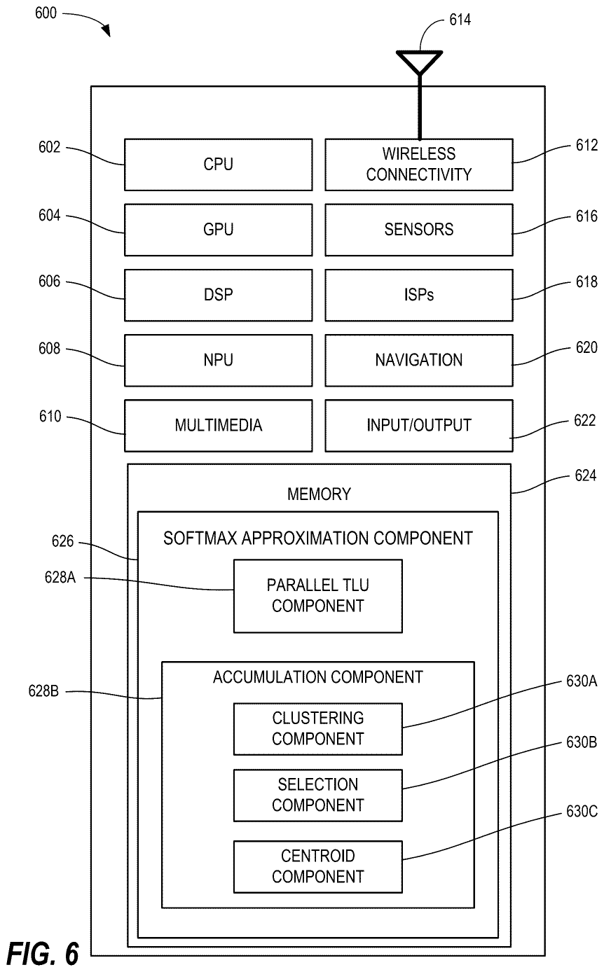

FIG. 5 illustrates example operations 500 for machine learning in a processing system, according to certain aspects of the present disclosure. In some aspects, the operations 500 may be performed, for example, by a machine learning system, such as the machine learning system 110 of FIG. 1. In some aspects, the operations 500 may be performed, for example, via a computing device, such as a user equipment (UE), a smartphone, a tablet computer, an autonomous vehicle, an edge device, or other computing system, such as the processing system 600 illustrated in FIG. 6 and described in further detail below.

As illustrated, the operations 500 begin at block 510, with generating an approximation of at least one component of an output vector of a normalized exponential function of a data vector. In some aspects, the normalized exponential function includes a softmax function in the machine learning model. In some aspects, block 510 may involve one or more of sub-blocks 520, 530, 540, and 550.

At sub-block 520, the operations 500 may involve determining, for each component of the data vector, an approximation of a natural exponential function of the component of the data vector, based on performing a hierarchical table lookup with two or more bits of the component of the data vector.

At sub-block 530, the operations 500 may involve performing an accumulation of the approximations of the natural exponential function of the components of the data vector, based at least in part on the hierarchical table lookups.

At sub-block 540, the operations 500 may involve using the accumulation as an approximation of a sum of the natural exponential function.

At sub-block 550, the operations 500 may involve dividing, for each component of the data vector, the approximation of the natural exponential function by the approximation of the sum of the natural exponential function to generate the approximation of the at least one component of the output vector.

At block 560, the operations 500 proceed with generating an output of a machine learning model based on the approximation of the at least one component of the output vector.

In some aspects, performing the hierarchical table lookup, at sub-block 520, involves selecting, from a plurality of banks of lookup tables, a bank of lookup tables, based on a first set of the two or more bits of the component of the data vector. Additionally, in some aspects, performing the hierarchical table lookup, at sub-block 520, involves: indexing each lookup table within the bank of lookup tables, based on a second set of the two or more bits of the component of the data vector; and determining, from the indexed lookup tables, a table entry comprising the approximation of the natural exponential function of the component of the data vector, based on the first set of the two or more bits of the component of the data vector.

In some aspects, the first set of the two or more bits of the component of the data vector comprises one or more MSBs of the component of the data vector, and the second set of the two or more bits of the component of the data vector comprises one or more LSBs of the component of the data vector.

In some aspects, each component of the data vector comprises data having a floating-point data type. In such aspects, the one or more MSBs of the component of the data vector may include one or more MSBs of an exponent portion of the component of the data vector, and the one or more LSBs of the component of the data vector may include one or more LSBs of the exponent portion of the component of the data vector.

In some aspects, each component of the data vector comprises data having a floating-point data type. In such aspects, the one or more MSBs of the component of the data vector may include one or more MSBs of a mantissa portion of the component of the data vector, and the one or more LSBs of the component of the data vector may include one or more LSBs of the mantissa portion of the component of the data vector.

In some aspects, each component of the data vector comprises data having a fixed-point data type. In such aspects, the one or more MSBs of the component of the data vector may include one or more MSBs of an integer portion of the component of the data vector, and the one or more LSBs of the component of the data vector may include one or more LSBs of the integer portion of the component of the data vector.

In some aspects, performing the accumulation of the approximations of the natural exponential function of the components of the data vector (at sub-block 530) involves determining a plurality of clusters, each cluster comprising a set of components of the data vector.

Additionally, in some aspects, performing the accumulation of the approximations of the natural exponential function of the components of the data vector (at sub-block 530) may involve, for each cluster, accumulating at least one approximation of the natural exponential function of at least one component of the data vector within the cluster into the approximation of the sum of the natural exponential function, after performing the hierarchical table lookup for the set of components of the data vector associated with the cluster. In such aspects, the at least one component of the data vector within the cluster may include a centroid of the cluster.

Additionally, in some aspects, performing the accumulation of the approximations of the natural exponential function of the components of the data vector (at sub-block 530) may involve (i) for each cluster within a first set of the plurality of clusters, refrain from accumulating any of the approximations of the natural exponential function associated with the set of components of the data vector within the cluster, and (ii) for each cluster within a second set of the plurality of clusters, accumulate an approximation of the natural exponential function of a centroid within the cluster. In some aspects, each set of components of the data vector within each cluster of the first set of the plurality of clusters has a value that is less than a threshold, and each set of components of the data vector within each cluster of the second set of the plurality of clusters has a value that is greater than or equal to the threshold. In some aspects, the threshold is associated with a predefined bitwidth.

### Example Processing System for Efficient Processing of a Softmax Activation Function

FIG. 6 depicts an example processing system 600 configured to perform various aspects of the present disclosure, including, for example, the techniques and methods described with respect to FIGS. 1-4. Although depicted as a single system for conceptual clarity, in at least some aspects, as discussed above, the operations described below with respect to the processing system 600 may be distributed across any number of devices.

The processing system 600 includes a central processing unit (CPU) 602, which in some examples may be a multi-core CPU. Instructions executed at the CPU 602 may be loaded, for example, from a program memory associated with the CPU 602 or may be loaded from a partition of memory 624.

The processing system 600 also includes additional processing components tailored to specific functions, such as a graphics processing unit (GPU) 604, a digital signal processor (DSP) 606, a neural processing unit (NPU) 608, a multimedia processing unit 610, and a wireless connectivity component 612.

An NPU, such as NPU 608, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation component 620, which may include satellite-based positioning system components (e.g., global positioning system (GPS) or global navigation satellite system (GLONASS)) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an advanced reduced instruction set computer (RISC) (ARM) or RISC-V instruction set.

In some examples, one or more of the processors of the processing system 600 may include one or more TLU units, such as TLU unit 410 illustrated in FIG. 4A, and one or more MAC units, such as MAC unit 420 illustrated in FIG. 4A.

The processing system 600 also includes the memory 624, which is representative of one or more static and/or dynamic memories, such as an SRAM, dynamic random access memory, a flash-based static memory, and the like. In this example, the memory 624 includes computer-executable components, which may be executed by one or more of the aforementioned processors of the processing system 600.

In particular, in this example, the memory 624 includes a softmax approximation component 626, which includes a parallel TLU component 628A and an accumulation component 628B. The accumulation component 628B includes a clustering component 630A, a selection component 630B, and a centroid component 630C. Though depicted as discrete components for conceptual clarity in FIG. 6, the illustrated components (and others not depicted) may be collectively or individually implemented in various aspects.

Generally, the processing system 600 and/or components thereof may be configured to perform the methods described herein.

Notably, in other aspects, elements of the processing system 600 may be omitted, such as where the processing system 600 is a server computer or the like. For example, the multimedia processing unit 610, the wireless connectivity component 612, the sensor processing units 616, the ISPs 618, and/or the navigation component 620 may be omitted in other aspects. Further, elements of the processing system 600 may be distributed between multiple devices.

### Example Clauses

Implementation details of various aspects of the present disclosure are described in the following numbered clauses:

Clause 1: A processor-implemented method for machine learning, comprising: generating an approximation of at least one component of an output vector of a normalized exponential function of a data vector, wherein generating the approximation comprises: determining, for each component of the data vector, an approximation of a natural exponential function of the component of the data vector, based on performing a hierarchical table lookup with two or more bits of the component of the data vector; performing an accumulation of the approximations of the natural exponential function of the components of the data vector, based at least in part on the hierarchical table lookups; using the accumulation as an approximation of a sum of the natural exponential function; and dividing, for each component of the data vector, the approximation of the natural exponential function by the approximation of the sum of the natural exponential function to generate the approximation of the at least one component of the output vector; and generating an output of a machine learning model based on the approximation of the at least one component of the output vector.

Clause 2: The processor-implemented method of Clause 1, wherein performing the hierarchical table lookup comprises selecting, from a plurality of banks of lookup tables, a bank of lookup tables, based on a first set of the two or more bits of the component of the data vector.

Clause 3: The processor-implemented method of Clause 2, wherein performing the hierarchical table lookup further comprises: indexing each lookup table within the bank of lookup tables, based on a second set of the two or more bits of the component of the data vector; and determining, from the indexed lookup tables, a table entry comprising the approximation of the natural exponential function of the component of the data vector, based on the first set of the two or more bits of the component of the data vector.

Clause 4: The processor-implemented method of Clause 3, wherein: the first set of the two or more bits of the component of the data vector comprises one or more most significant bits (MSBs) of the component of the data vector; and the second set of the two or more bits of the component of the data vector comprises one or more least significant bits (LSBs) of the component of the data vector.

Clause 5: The processor-implemented method of Clause 4, wherein: each component of the data vector comprises data having a floating-point data type; the one or more MSBs of the component of the data vector comprise one or more MSBs of an exponent portion of the component of the data vector; and the one or more LSBs of the component of the data vector comprise one or more LSBs of the exponent portion of the component of the data vector.

Clause 6: The processor-implemented method of Clause 4, wherein: each component of the data vector comprises data having a floating-point data type; the one or more MSBs of the component of the data vector comprise one or more MSBs of a mantissa portion of the component of the data vector; and the one or more LSBs of the component of the data vector comprise one or more LSBs of the mantissa portion of the component of the data vector.

Clause 7: The processor-implemented method of Clause 4, wherein: each component of the data vector comprises data having a fixed-point data type; the one or more MSBs of the component of the data vector comprise one or more MSBs of an integer portion of the component of the data vector; and the one or more LSBs of the component of the data vector comprise one or more LSBs of the integer portion of the component of the data vector.

Clause 8: The processor-implemented method in accordance with any of Clauses 1-7, wherein performing the accumulation of the approximations of the natural exponential function of the components of the data vector comprises determining a plurality of clusters, each cluster comprising a set of components of the data vector.

Clause 9: The processor-implemented method of Clause 8, wherein performing the accumulation of the approximations of the natural exponential function of the components of the data vector comprises, for each cluster, accumulating at least one approximation of the natural exponential function of at least one component of the data vector within the cluster into the approximation of the sum of the natural exponential function, after performing the hierarchical table lookup for the set of components of the data vector associated with the cluster.

Clause 10: The processor-implemented method of Clause 9, wherein the at least one component of the data vector within the cluster comprises a centroid of the cluster.

Clause 11: The processor-implemented method in accordance with any of Clauses 9-10, wherein performing the accumulation of the approximations of the natural exponential function comprises: for each cluster within a first set of the plurality of clusters, refraining from accumulating any of the approximations of the natural exponential function associated with the set of components of the data vector within the cluster; and for each cluster within a second set of the plurality of clusters, accumulating an approximation of the natural exponential function of a centroid within the cluster.

Clause 12: The processor-implemented method of Clause 11, wherein: each set of components of the data vector within each cluster of the first set of the plurality of clusters has a value that is less than a threshold; and each set of components of the data vector within each cluster of the second set of the plurality of clusters has a value that is greater than or equal to the threshold.

Clause 13: The processor-implemented method of Clause 12, wherein the threshold is associated with a predefined bitwidth.

Clause 14: The processor-implemented method in accordance with any of Clauses 1-13, wherein the normalized exponential function comprises a softmax function in the machine learning model.

Clause 15: A processing system comprising: one or more memories comprising processor-executable instructions; and one or more processors coupled to the one or more memories and configured to execute the processor-executable instructions and cause the processing system to perform a method in accordance with any of Clauses 1-14.

Clause 16: A processing system comprising means for performing a method in accordance with any of Clauses 1-14.

Clause 17: A non-transitory computer-readable medium comprising computer-executable instructions that, when executed by one or more processors of a processing system, cause the processing system to perform a method in accordance with any of Clauses 1-14.

Clause 18: A computer program product embodied on a computer-readable storage medium comprising code for performing a method in accordance with any of Clauses 1-14.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning comprising:
one or more memories comprising processor-executable instructions; and
one or more processors coupled to the one or more memories and configured to execute the processor-executable instructions and cause the processing system to:
generate an approximation of at least one component of an output vector of a normalized exponential function of a data vector, wherein, to generate the approximation, the one or more processors are configured to execute the processor-executable instructions and further cause the processing system to:
determine, for each component of the data vector, an approximation of a natural exponential function of the component of the data vector, based on performing a hierarchical table lookup with two or more bits of the component of the data vector;
perform an accumulation of the approximations of the natural exponential function of the components of the data vector, based at least in part on the hierarchical table lookups;
use the accumulation as an approximation of a sum of the natural exponential function; and
divide, for each component of the data vector, the approximation of the natural exponential function by the approximation of the sum of the natural exponential function to generate the approximation of the at least one component of the output vector; and
generate an output of a machine learning model based on the approximation of the at least one component of the output vector.

2. The processing system of claim 1, wherein, to perform the hierarchical table lookup, the one or more processors are configured to execute the processor-executable instructions and further cause the processing system to select, from a plurality of banks of lookup tables, a bank of lookup tables, based on a first set of the two or more bits of the component of the data vector.

3. The processing system of claim 2, wherein, to perform the hierarchical table lookup, the one or more processors are configured to execute the processor-executable instructions and further cause the processing system to:
index each lookup table within the bank of lookup tables, based on a second set of the two or more bits of the component of the data vector; and
determine, from the indexed lookup tables, a table entry comprising the approximation of the natural exponential function of the component of the data vector, based on the first set of the two or more bits of the component of the data vector.

4. The processing system of claim 3, wherein:
the first set of the two or more bits of the component of the data vector comprises one or more most significant bits (MSBs) of the component of the data vector; and
the second set of the two or more bits of the component of the data vector comprises one or more least significant bits (LSBs) of the component of the data vector.

5. The processing system of claim 4, wherein:
each component of the data vector comprises data having a floating-point data type;
the one or more MSBs of the component of the data vector comprise one or more MSBs of an exponent portion of the component of the data vector; and
the one or more LSBs of the component of the data vector comprise one or more LSBs of the exponent portion of the component of the data vector.

6. The processing system of claim 4, wherein:
each component of the data vector comprises data having a floating-point data type;
the one or more MSBs of the component of the data vector comprise one or more MSBs of a mantissa portion of the component of the data vector; and
the one or more LSBs of the component of the data vector comprise one or more LSBs of the mantissa portion of the component of the data vector.

7. The processing system of claim 4, wherein:
each component of the data vector comprises data having a fixed-point data type;
the one or more MSBs of the component of the data vector comprise one or more MSBs of an integer portion of the component of the data vector; and
the one or more LSBs of the component of the data vector comprise one or more LSBs of the integer portion of the component of the data vector.

8. The processing system of claim 1, wherein, to perform the accumulation of the approximations of the natural exponential function of the components of the data vector, the one or more processors are configured to execute the processor-executable instructions and further cause the processing system to determine a plurality of clusters, each cluster comprising a set of components of the data vector.

9. The processing system of claim 8, wherein, to perform the accumulation of the approximations of the natural exponential function of the components of the data vector, the one or more processors are configured to execute the processor-executable instructions and further cause the processing system to, for each cluster, accumulate at least one approximation of the natural exponential function of at least one component of the data vector within the cluster into the approximation of the sum of the natural exponential function, after performing the hierarchical table lookup for the set of components of the data vector associated with the cluster.

10. The processing system of claim 9, wherein the at least one component of the data vector within the cluster comprises a centroid of the cluster.

11. The processing system of claim 9, wherein, to perform the accumulation of the approximations of the natural exponential function, the one or more processors are configured to execute the processor-executable instructions and further cause the processing system to:
for each cluster within a first set of the plurality of clusters, refrain from accumulating any of the approximations of the natural exponential function associated with the set of components of the data vector within the cluster; and
for each cluster within a second set of the plurality of clusters, accumulate an approximation of the natural exponential function of a centroid within the cluster.

12. The processing system of claim 11, wherein:
each set of components of the data vector within each cluster of the first set of the plurality of clusters has a value that is less than a threshold; and
each set of components of the data vector within each cluster of the second set of the plurality of clusters has a value that is greater than or equal to the threshold.

13. The processing system of claim 12, wherein the threshold is associated with a predefined bitwidth.

14. The processing system of claim 1, wherein the normalized exponential function comprises a softmax function in the machine learning model.

15. A processor-implemented method for machine learning, comprising:
generating an approximation of at least one component of an output vector of a normalized exponential function of a data vector, wherein generating the approximation comprises:
determining, for each component of the data vector, an approximation of a natural exponential function of the component of the data vector, based on performing a hierarchical table lookup with two or more bits of the component of the data vector;
performing an accumulation of the approximations of the natural exponential function of the components of the data vector, based at least in part on the hierarchical table lookups;
using the accumulation as an approximation of a sum of the natural exponential function; and
dividing, for each component of the data vector, the approximation of the natural exponential function by the approximation of the sum of the natural exponential function to generate the approximation of the at least one component of the output vector; and
generating an output of a machine learning model based on the approximation of the at least one component of the output vector.

16. The processor-implemented method of claim 15, wherein performing the hierarchical table lookup comprises selecting, from a plurality of banks of lookup tables, a bank of lookup tables, based on a first set of the two or more bits of the component of the data vector.

17. The processor-implemented method of claim 16, wherein performing the hierarchical table lookup further comprises:
indexing each lookup table within the bank of lookup tables, based on a second set of the two or more bits of the component of the data vector; and
determining, from the indexed lookup tables, a table entry comprising the approximation of the natural exponential function of the component of the data vector, based on the first set of the two or more bits of the component of the data vector.

18. The processor-implemented method of claim 15, wherein performing the accumulation of the approximations of the natural exponential function of the components of the data vector comprises determining a plurality of clusters, each cluster comprising a set of components of the data vector.

19. The processor-implemented method of claim 18, wherein performing the accumulation of the approximations of the natural exponential function of the components of the data vector comprises, for each cluster, accumulating at least one approximation of the natural exponential function of at least one component of the data vector within the cluster into the approximation of the sum of the natural exponential function, after performing the hierarchical table lookup for the set of components of the data vector associated with the cluster.

20. A processing system comprising:
means for generating an approximation of at least one component of an output vector of a normalized exponential function of a data vector, wherein the means for generating the approximation comprises:
means for determining, for each component of the data vector, an approximation of a natural exponential function of the component of the data vector, based on means for performing a hierarchical table lookup with two or more bits of the component of the data vector;
means for performing an accumulation of the approximations of the natural exponential function of the components of the data vector, based at least in part on the hierarchical table lookups;
means for using the accumulation as an approximation of a sum of the natural exponential function; and
means for dividing, for each component of the data vector, the approximation of the natural exponential function by the approximation of the sum of the natural exponential function to generate the approximation of the at least one component of the output vector; and
means for generating an output of a machine learning model based on the approximation of the at least one component of the output vector.
